(19) United States
(12) Patent Application Publication
(10) Pub. No.: US 2009/0015195 A1
(43) Pub. Date: Jan. 15, 2009

(54) Device with Electric Appliance and Charging Station

(76) Inventor: Hartmut Loth-Krausser, Stockstadt am Rhein (DE)

Correspondence Address: FISH & RICHARDSON PC, P.O. BOX 1022, MINNEAPOLIS, MN, 55440-1022, US

(21) Appl. No.: 12/166,937

(22) Filed: Jul. 2, 2008

(30) Foreign Application Priority Data
Jul. 4, 2007 (DE) 10 2007 031 008.2

(51) Int. Cl. H02J 7/00

(52) U.S. Cl. 320/107

(57) ABSTRACT

A system includes an electric appliance, which is operated with replaceable and rechargeable batteries, a charging station and two or more battery units. The charging station has two or more receptacles for holding and charging the battery units. A first coupling is provided between a battery unit and the appliance and a second coupling is provided between a battery unit and the charging station such that a battery unit connected to the appliance can be uncoupled from the appliance by one-handed operation and can be coupled to the charging station for charging by one-handed operation. Similarly, a battery unit connected to the charging station can be coupled to the appliance and uncoupled from the charging station by one-handed operation.

### CROSS-REFERENCE TO RELATED APPLICATIONS

This application claims priority to German Patent Application No. DE 10 2007 031 008.2 filed Jul. 4, 2007.

### FIELD OF THE INVENTION

This disclosure relates to devices with electric appliances powered by replaceable or rechargeable batteries.

### BACKGROUND OF THE INVENTION

Electric appliances are often powered by replaceable and rechargeable batteries. In particular, personal appliances use batteries that are kept small for ergonomic reasons, may be completely discharged during a single use, and may require rapid charging of the batteries to be able to operate again as a wireless appliance after a short period of time. Appliances with especially high power demands for a short time include hair curling irons, hair straighteners, hair dryers, hand-held blenders and power tools. Digital cameras, cell phones and other electronic devices have a somewhat lower power demand.

Multiple battery cells are usually combined within a housing to form a battery unit. A single battery cell may also be used for certain applications. The user can then temporarily separate the battery unit from the appliance for charging or for replacement. To minimize the interruption time for recharging during a use, a fully discharged battery unit may be replaced by a charged battery unit. The appliance and battery unit are often designed so that two hands are required for separating and reconnecting them.

British Patent 2,299,755 discloses a battery-operated hair dryer having a battery unit held on the appliance handle. The appliance with the connected battery unit may be inserted into a receptacle in a special charging station.

### SUMMARY OF THE INVENTION

One aspect of the invention features a system including, a charging station, an electric appliance and a first removable, rechargeable battery unit, wherein: the electric appliance and first battery unit are connectable by first connecting means to form a first coupling for powering the electric appliance. The charging station defines a receptacle configured to hold and charge the first battery unit; the charging station and first battery unit are connectable by second connecting means to form a second coupling for charging the first battery unit. The first coupling and the second coupling are configured such that respective formation of one coupling and separation of the other coupling is readily accomplished by one-handed operation.

In some embodiments, the first and second coupling each include a mechanical lock and electric contacts.

In some embodiments, the combination further includes a second receptacle defined in the charging station and configured to hold and charge one of the first battery unit and a second battery unit.

In some embodiments, the battery unit includes electric contacts positioned on opposed surfaces of the battery unit.

In some embodiments, the first and second couplings are configured to prevent polarity reversal of the battery unit with electric contacts in the respective coupling.

In some embodiments, the battery unit is configured to prevent polarity reversal of electric contacts on the battery unit relative to electric contacts on the appliance or charging station.

In some embodiments, the battery unit is configured to be positionally reversible between the first and second couplings.

In some embodiments, the first and second couplings are substantial symmetrical to accommodate positional reversal of the battery unit.

In some embodiments, at least one of the first and second couplings is configured to be made or uncoupled by rotation of the appliance.

In some embodiments, the battery unit is configured to be locked to the charging station by rotation of the appliance about a longitudinal axis of the appliance and the battery unit.

In some embodiments, one of the first and second couplings is configured to be made or uncoupled by operation of a spring-pushbutton system similar to that of a ballpoint pen.

In some embodiments, the battery unit includes an exterior housing and an interior housing movable within the exterior housing against the force of a spring.

In some embodiments, the battery unit includes an actuator operable from the battery exterior to engage mechanical locks between the battery unit and one of the charging station and the appliance to form one of the first and second couplings.

In some embodiments, the actuator is a slider.

In some embodiments, one of the appliance and the charging station includes a rigid locking member for coupling the battery unit.

In some embodiments, the rigid locking member includes a coupling pin defining an undercut, and the battery unit includes a movable locking member configured to engage the undercut.

In some embodiments, the movable locking member includes a lever movable to engage the undercut.

In some embodiments, the battery unit includes movable locking levers movable by contact with movable leading surfaces.

In some embodiments, the leading surfaces include a conical pin on one of the appliance and the charging station.

Another aspect of the invention features a device including an electric appliance which is operated with a replaceable, rechargeable battery unit; a charging station including two or more receptacles for holding and charging two or more battery units; first connecting means between the battery unit and the appliance; and second connecting means between the battery unit and the charging station, such that the battery unit when connected to the appliance can be uncoupled from the appliance and coupled to the charging station for charging by one-handed operation and the battery unit when connected to the charging station can be coupled to the appliance and uncoupled from the charging station by one-handed operation.

Another aspect of the invention features a method of alternately coupling a rechargeable battery to an appliance and a charging station. The method includes the steps of: coupling the battery to the charging station; gripping the appliance with one hand; coupling the appliance to the battery on the charging station while gripping the appliance with one hand and without gripping the battery or the charging station; and uncoupling the battery from the charging station while gripping the appliance with one hand without gripping the battery or the charging station.

In some applications, the coupling of the appliance to the battery and the uncoupling of the battery from the charging system are performed substantially simultaneously by rotating the appliance in contact with the battery.

In one aspect, a discharged battery unit of an appliance is replaceable with a charged battery unit kept in readiness on the charging station. In some cases, the battery is readily replaceable with one hand

In one embodiment, an electric device includes a first releasable connection or “coupling” between a battery unit and an appliance and a second releasable connection or coupling between a battery unit and a charging station, so that a battery unit coupled to the appliance can be uncoupled from the appliance by one-handed operation and can be coupled to the charging station for charging and/or so that a battery unit coupled to the charging station can be coupled to the appliance by one-handed operation and can be uncoupled from the charging station by one-handed operation. Thus, with two batteries, one battery unit can be on the appliance during ongoing operation, while the other battery unit is connected to the charging station to be charged.

Some examples of one-handed operation include operations in which:
the transfer of the battery unit from the appliance to the charging station (coupling the battery unit to the charging station and uncoupling the battery unit from the appliance) is possible by means of a single linear movement (plugging movement) of the appliance to the battery unit, or
in which a single linear movement is combined with a subsequent or preceding rotational movement, or
in which a single linear movement of the hand with the battery unit is combined with exerting a pressure, pivoting or sliding movement by the thumb or another finger of the active hand of the user.

Transfer of a charged battery from the charging station to the appliance can involve similar operations. The invention is not limited, however, to these types of one-handed operations.

In some cases, the user need not change his or her grip in one-handed operation to remove or attach a battery. In a particular instance, the user's hand holds the appliance, guides the coupled battery unit into the receptacle on the charging station, uncouples the battery unit from the appliance and couples it to the charging station by means of one or two movements. For example, a linear movement for plugging the battery unit into the receptacle of the charging station is considered to be one movement and any rotational movement of the battery unit (with the appliance) or optional operation of a pushbutton, a lever or a slide is considered to be a second movement.

According to another aspect, the first and second couplings each include a mechanical lock and electric contacts. In some instances, mechanical locking is achieved by non-positive engagement, frictional engagement or form-fitting engagement. For example, a self-locking feature or form-fitting feature can be biased or held in position by being acted upon by a spring.

In some embodiments, the electric contacts are integrated into the mechanical lock, in particular into movable parts of the mechanical lock, or are arranged in separate spaced locations.

In some embodiments, the battery units have electric contacts for connection both to the appliance and the charging station, so that one battery unit may be connected to the appliance and to the charging station at the same time. This also facilitates and simplifies rapid one-handed replacement of the battery units. In a particular embodiment, the battery units have electric contacts on opposing sides, e.g. one positive terminal and one negative terminal each on the two sides.

According to another aspect, the electric connection between the battery unit and the appliance and/or between the battery unit and the charging station is protected from reversal of polarity, in particular through electric contacts designed to safeguard against or prevent reversal of polarity. This prevents creation of offset voltages or short circuits.

In some embodiments, asymmetric design of the couplings requires a certain alignment between the battery unit and the appliance or charging station.

In another embodiment, in the case of battery unit that can be attached in various angular positions, the contacts are arranged in the shape of partial rings.

According to another aspect, the first and second couplings are designed to be symmetrical with one another such that the battery units each have two connecting devices that can be connected both and/or optionally to a connecting device on the appliance as well as to a connecting device on the charging station. Therefore, during installation or removal of a battery unit, its alignment relative to the appliance and/or to the charging station need not be taken into account.

According to another aspect, the first and/or second couplings are designed in such that a battery unit can be unlocked from the appliance by means of a rotational movement of the appliance and can be locked to the charging station by a rotational movement about an axis that extends from the appliance through the battery unit to the charging station. In particular instances, the axis of rotation runs parallel to the longitudinal axis of the battery unit or coincides with the longitudinal axis. The axis of rotation may also be aligned perpendicular to the surface of the charging station.

According to another aspect, the couplings are designed so that a battery unit can be connected to the appliance and/or the charging station by a spring-pushbutton system. This makes it possible to connect the battery unit to the charging station by a single plugging movement and at the same time to release it from the appliance.

In a further embodiment of the invention, the battery unit has an exterior housing and an interior housing, whereby the interior housing is movable against the force of spring in the exterior housing. The interior housing is thus extendable similar in operation to a ballpoint pen.

According to another aspect, an externally operable actuator is provided for operation of mechanical locks between the battery unit and the charging station and/or the battery unit and the appliance. In a particular embodiment, the actuator is a slide. The slide can be coupled to suitable locking means via levers. The actuator can be arranged on the battery unit, appliance or charging station.

According to another aspect, the charging station has one connecting device with a rigid locking means—for connection of the battery units. In a particular embodiment, a coupling pin includes an undercut and the battery unit has a connecting device with movable locking means such as a lever that is movable behind the undercut. The lever and the undercut thus form a locked form-fitting engagement.

The appliance can also have a connecting device with a rigid locking means for connection of the battery unit, in particular a coupling pin with an undercut, while the battery unit has a connecting device corresponding thereto with movable locking means, such as a lever movable behind the undercut. Thus, a detachable form-fitting engagement between the lever and undercut is possible.

According to another aspect, battery unit has movable levers as locking means and the levers are movable in response to movable leading surfaces. In a particular embodiment, the leading surfaces are parts of a conical pin of the battery unit, the appliance and/or the charging station and the levers include an angled arm that engages behind the undercut and another arm that is in contact with the leading surface.

According to another aspect, the coupling and uncoupling of the battery units may be performed by simple two-handed operation. For example, with the first hand, a linear movement of the battery unit (with the appliance) is executed, e.g., a plugging or unplugging movement. The second hand executes a linear movement with which a mechanical lock and/or electric connection is established or undone. For example a switch on the charging station can be acted upon by the second hand for electromagnetic operation of the mechanical lock. If the first hand need not perform a holding function, then the function of the second hand may also be replaced by the first hand after releasing the battery unit and/or the appliance.

The various embodiments and properties of the changing mechanisms are explained systematically below. A distinction is made between the type of locking or coupling, the means for controlling the locking or coupling and the position of the means for controlling the locking or coupling:
The lock may act mechanically, by non-positive engagement, frictional engagement or form-fitting engagement.
The lock can function magnetically. For example, an electromagnet may secure an appliance and a battery unit and/or a battery unit and charging station.
The means for controlling the lock can be of a mechanical type, e.g., slide, lever or pressure elements. The control of the lock can also be accomplished alone or additionally by moving the appliance with the battery unit, e.g., by rotating, moving up or down, by pivoting or by some other method.
The means for controlling the lock can be of an electric type or an optoelectronic type. For example, a pushbutton, sensor or switch controls a magnet to either generate the coupling force or move the mechanical means for coupling or locking.
In some embodiments, an automatic electric controller for the lock and/or coupling recognizes the “fully discharged” charge status of the first battery unit and triggers its uncoupling from the appliance and coupling to the charging station. Furthermore, the system recognizes the “fully charged” of the second battery unit and triggers the coupling to the appliance and the uncoupling from the charging station.
The means for controlling the lock and/or coupling may be located on the appliance, battery unit or charging station.
“One handed” operation means that the user grips the appliance with one hand to readily perform the coupling and uncoupling of the battery to the appliance or charging system without releasing the grip and without the need to grip either the battery or charging station with the other hand. In some cases, a single movement of the appliance by the gripping hand can simultaneously couple the battery to the appliance while uncoupling the battery from the chargins system, or vice versa. For example, rotation of the appliance in contact with the battery can engage or register angularly spaced projections or pins and cavities between the battery and appliance while simultaneously disengaging similar features between the battery and charging station. Other embodiments permit one handed and even simultaneous coupling and decoupling through push button or slide lock operation, translatory movement of the appliance along a longitudinal axis, and the like.
In a particular embodiment, “one-handed” operation for changing the battery units means that the guiding hand moves the battery unit with the appliance without letting go. “Without letting go” also means that means for controlling the lock on the charging station, appliance or battery unit can be activated by the guiding hand, e.g. by movement of one or more fingers. One-handed operation with letting go of the appliance (and/or the battery unit) in between or two-handed operation is also possible, e.g., with an arrangement of the means for controlling the lock/coupling to the charging station.

### BRIEF DESCRIPTION OF THE DRAWINGS

Moreover, additional features and advantages of the invention are derived from the description, drawings and claims. Advantageous exemplary embodiments of the invention are explained in greater detail below on the basis of drawings, in which like reference symbols indicate like elements.

FIG. 1 is a schematic diagram of a charging station with standing battery units and an electric appliance connected to the battery unit.

FIG. 2 is a perspective view of a charging station with hanging battery units and the appliance hanging in relation to the charging station.

FIG. 3 is a longitudinal sectional view of through the arrangement according to FIG. 1 along line C-C, whereby the battery unit is replaced by a plugging and rotational movement of the appliance together with the battery unit.

FIG. 3a is a cross sectional view through first coupling 8 according to FIG. 1 along line A-A (plugging-rotational connection).

FIG. 3b is a cross sectional view through second coupling 9 according to FIG. 1 along line B-B (plugging-rotational movement).

FIG. 4 is a longitudinal sectional view like that in FIG. 3 with the appliance, battery unit and charging station to illustrate a changing mechanism like the mechanism of a ballpoint pen, namely an up-and-down movement in the direction of a longitudinal axis.

FIG. 5 is a longitudinal sectional view like that in FIG. 4 but with a changing mechanism with a slide on the battery unit.

FIG. 6 is a longitudinal sectional view like that in FIG. 5 but with an electromagnetically controlled lock.

### DETAILED DESCRIPTION

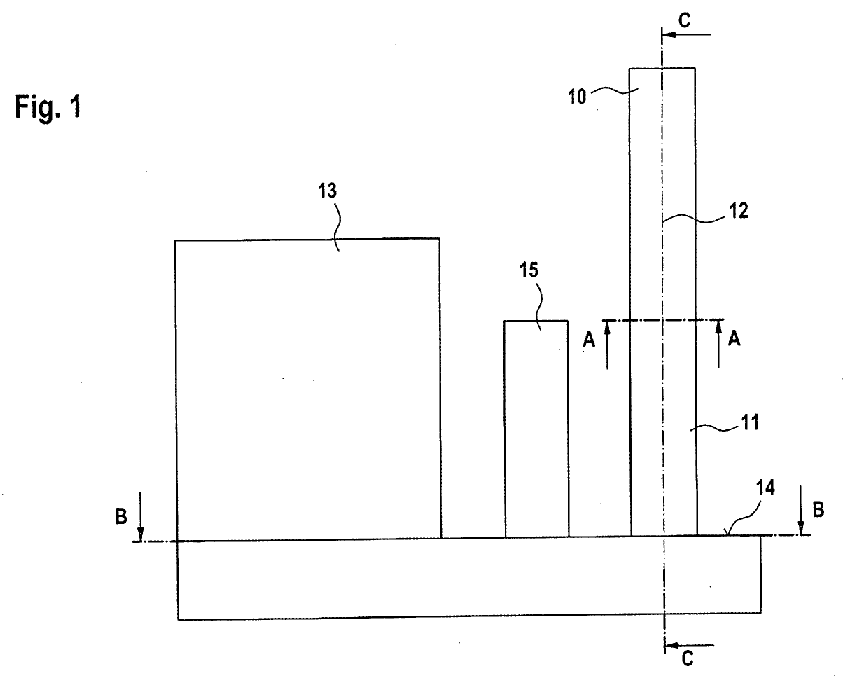

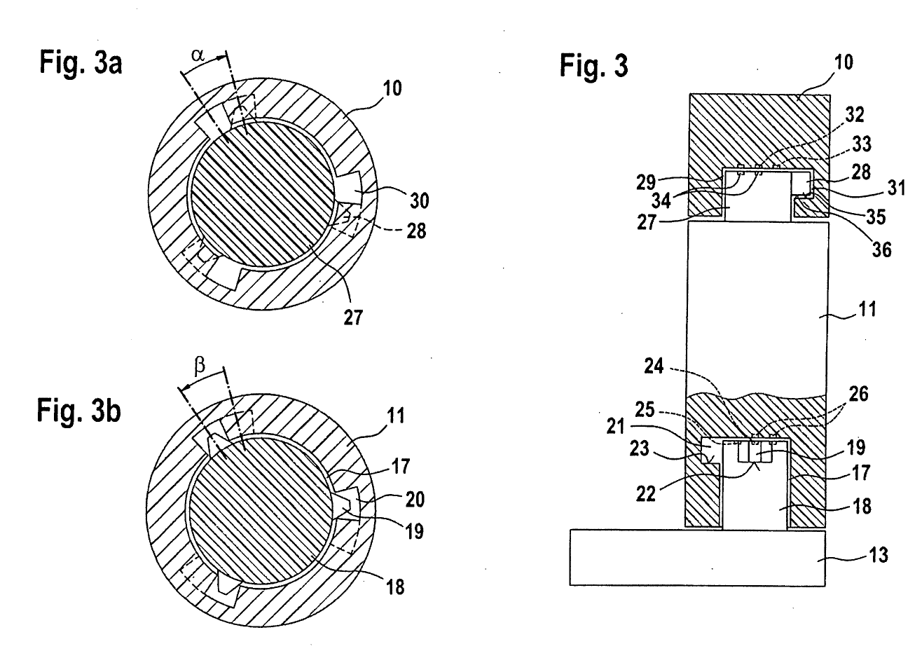

With reference to FIG. 1, an electric appliance 10, e.g., a hand-held blender, is electrically and mechanically connected to a battery unit 11. Appliance 10 and battery unit 11 are elongated and arranged about a common longitudinal axis 12. A longitudinal axis 12 also marks a section plane C-C for the diagram in FIG. 3.

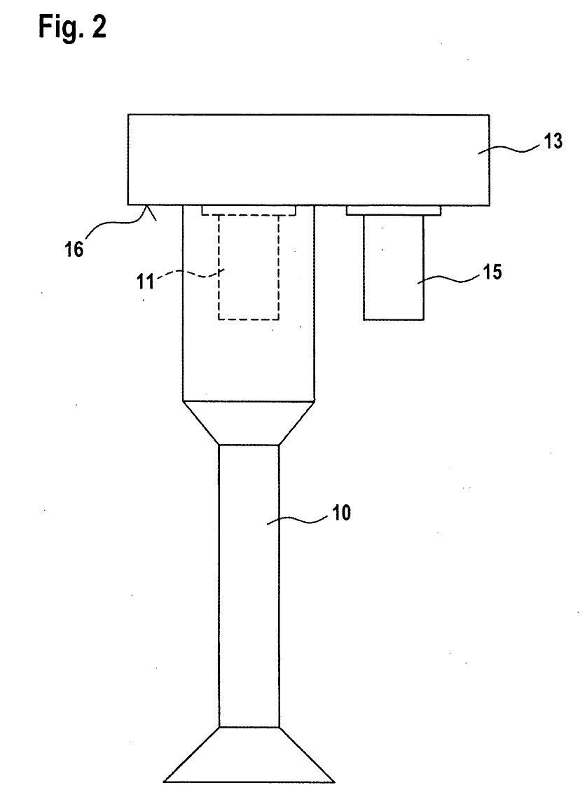

The battery unit 11 is electrically and mechanically connected to a charging station 13 at its end opposite the appliance 10. The charging station 13 includes suitable receptacles (not shown in FIGS. 1 and 2). The battery unit 11 stands perpendicular to and/or relative to a surface 14 of the charging station 13. The mechanical connection may include a mechanical lock and/or a contact pressure.

In addition to the battery unit 12, another battery unit 15 also electrically and mechanically connected to the charging station 13. In the arrangement in FIG. 1, both battery units 11, 15 are charging. At the same time, the battery unit 11 can be removed easily together with the appliance 10 from the charging station 13.

FIG. 2 shows a hanging arrangement of the charging station 13, battery units 11, and appliance 10. The battery units 11, 15 are held detachably on an underside 16 of the charging station 13. The appliance 10 (a hand-held blender) is plugged onto the battery unit 11 and is at least electrically and mechanically connected thereto. In addition, there can be a mechanical connection to the charging station 13. The appliance 10 is plugged onto the battery unit 11 and suspended from the charging station 13.

Charging station 13, appliance 10 and each battery unit 11, 15 are provided with locking members to make first and second releasable couplings 8 and 9, that make it possible to uncouple the battery unit 11 from the appliance 10 and connect it to the charging station 13 with one hand and to also connect the other battery unit 15 to the appliance 10 and uncouple it from the charging station 13 with one hand.

The charging station 13 can be stabilized against movement from by the aforementioned hand movements. This can be accomplished, for example, through adhesion to or friction on a standing surface, through sufficiently great mass or through securing it tightly to a wall or a ceiling.

Details of the couplings 8 and 9 between the charging station 13, the battery units 11, 15 and the appliance 10 are explained below with reference to FIGS. 3-5.

In the embodiment according to FIGS. 3, 3a and 3b, couplings 8 and 9 are provided between the battery units (battery unit 11) and the appliance on the one hand and between the battery units and the charging station 13 on the other hand, so that coupling of the battery unit to the charging station 13 and uncoupling of the same battery unit from the appliance 10 can be performed by a plugging and rotational movement. First, the battery unit 11 that is connected to the appliance 10 with a cylindrical recess 17 is plugged onto a corresponding protrusion 18 on the charging station 13. The protrusion 18 extends upward from the surface 14 as a receptacle for the battery unit 11. Alternatively, a hanging arrangement according to FIG. 2 is also possible.

The protrusion 18 has at least one pin on an upper end 19 In the present case, three pins 19 are directed sideways and spaced equidistantly around the protrusion 18. The recess 17 has corresponding longitudinal slots 20 to which are connected cavities 21 in the circumferential direction, these cavities being of such a size that they can receive the pins 19. The pin 19 has a supporting surface on the bottom side, that is adapted to a contact surface 23 on the top side of the respective cavity 21.

After plugging the battery unit 11 onto the protrusion 18, the device 10 with the battery unit 11 is rotated about its longitudinal axis (see FIG. 1), so that the pins 19 enter into the cavities 21 and the contact surfaces 22 frictionally engage the contact surfaces 23. Thus, charging station 13 and battery unit 11 are mechanically locked together.

An electric connection between battery unit 11 and charging station 13 is achieved by a central contact 24 and a ring contact 25 on the protrusion 18 on the one hand and a contact pair 26 on the battery unit 11 on the other hand. After plugging and rotating the battery unit 11 on the protrusion 18, the contact pair 16 is in compressed contact with the contacts 24, 25 to transmit high currents with low losses.

The connection between the battery unit 11 and the appliance 10 functions similar to the above described connection between the charging station 13 and the battery unit 11. A cylindrical protrusion 27 with pins 28 is present on the battery unit 11 and protrudes into a corresponding cylindrical recess 29 on the appliance 10. The pins 28 enter longitudinal slots 30 by plug connection of the battery unit 11 and enter the cavities 31 by a subsequent rotational movement. An electric connection between the battery unit 11 and the appliance 10 is established by a central contact 32 and a ring contact 33 on the appliance 10 on the one hand and a contact pair 34 on the pin 27 of the battery unit 11 on the other hand. The contacts and contact pairs may be transposed in other embodiments. The electric contacts can be arranged independent of the angle of rotation or may be arranged such that there is an electric connection only after rotation of the contacts.

The cavities 21 and 31 are arranged relative to the longitudinal slots 20 and 30 so that through a single rotational movement of the appliance 10, a mechanical and electric contact or even a locking effect is achieved between the battery unit 11 and the charging station 13. At the same time, the mechanical contact between the battery unit 11 and the appliance 10 is released in that the pins 28 are moved out of the cavities 31 and into the longitudinal slots 30. The appliance 10 can then be raised up from the protrusion 27 in the direction of the longitudinal axis 12.

The rotational movement can be divided into two partial rotational movements, namely a rotational angle alpha (see FIG. 3a) and a rotational angle beta (see FIG. 3b). Depending on the prevailing frictional conditions in the area of the contact faces 22, 23 and 35, 36, a sequence or super positioning of the relative rotations between appliance 10 and battery unit 11 on the one hand and charging station 13 and battery unit 11 on the other hand is established. The user rotates the appliance 10 by the sum of the angles alpha and beta, so that the pins 28 enter the area of the longitudinal slots 30 and the pins 19 come out of the longitudinal slots 20 and enter the cavities 21.

Similar to the pins 18, an additional pin, (not shown in FIG. 3), is provided on the charging station 13 to receive the battery unit 15 shown in FIG. 1. The appliance 10, which has been separated from the battery unit 11, can be plugged onto the battery unit 15. Due to the rotational movement described above, the battery unit 15 may be electrically and mechanically connected to the appliance 10 simultaneously electrically and mechanically decoupled from the charging station 13.

The particular embodiment shown to FIG. 3 is also advantageous in conjunction with the hanging arrangement according to FIG. 2. The battery unit, which is hanging from the charging station 13, reliably secured. The electric contacts are arranged in a manner that is secure against polarity reversal.

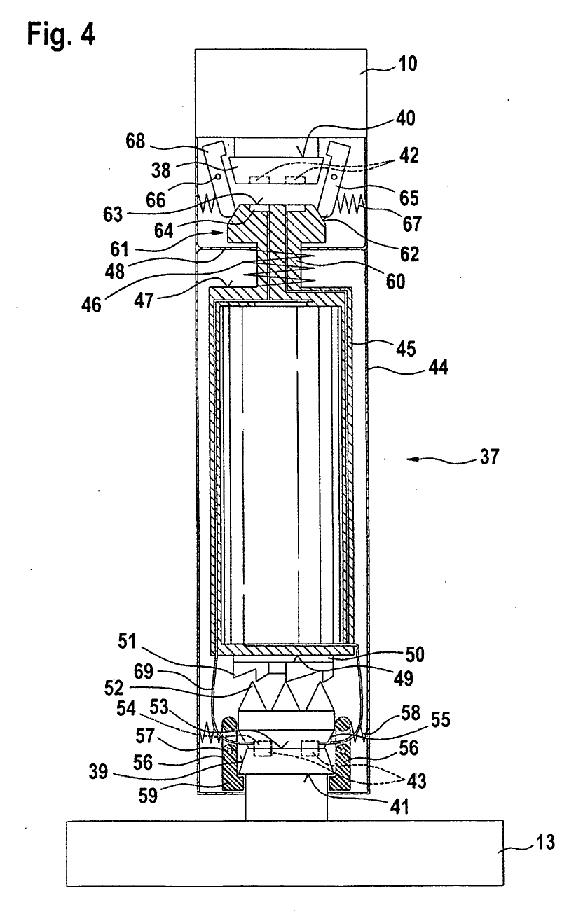

In the embodiment according to FIG. 4, the first and second couplings 8a and 9a are provided between appliance 10 and battery unit 11 on the one hand and between battery unit 11 and charging station 13 on the other hand, so that an up-and-down movement in the direction of the longitudinal axis is sufficient for coupling and uncoupling the respective battery unit. The handling is similar to operation of a ballpoint pen with a spring-pushbutton system. The functionality of the spring-pushbutton system is simulated by a special design of battery unit 37. Appliance 10 and charging station 13 each have as receptacles a protrusion with a conical head 38, 39, having a peripheral undercut 40, 41 and a contact pair 42, 43 at the top.

The battery unit 37 is designed in multiple parts, namely with an exterior housing 44 and an interior housing 45, which is axially movable in the exterior housing against the pressure of a spring 46. The spring presses against an end wall 47 of the interior housing 45 at one end and at the other end presses against a counter bearing 48 fixedly arranged in the exterior housing 44.

A rotatable disk 50 and a first toothed ring 51 are arranged in the area of other end wall 49 of the interior housing 45. A second toothed ring 52, which is axially movable (not shown) in the exterior housing 44 and is in contact with the conical head of the cone with its side 53 facing away from the teeth of ring 52. A contact pair 54 is arranged on the side 53 and is in contact with the contact pair 43 in the diagram in FIG. 4 to establish electric contact between the battery unit 37 and charging station 13.

Starting from the side 53, the second toothed ring 52 has a cone 55, which acts on one end of spring-mounted levers 56 in the exterior housing 44 by movement in the longitudinal direction. The levers 56 include two arms and are pivotable about a fulcrum 57 with a first lever arm that is acted upon by a spring 58 and pressed against the cone 55. In doing so, the spring 58 is supported on the exterior housing 44. A second lever arm is designed as a claw 59 and can engage behind the undercut 41.

Starting from the end wall 47, a protrusion 60 extends concentrically with the spring 46. The protrusion 60 defines a head 61, which is provided with a cone 62 like the cone 55, with an end face 63 like the side 53. An electric contact pair 64 is arranged on the end face 63.

The exterior housing 44 defines openings on both end faces for admitting the cone head 39 of the charging station 13 and/or the cone head 38 of the appliance 10. By analogy with the levers 56, two-armed levers 65 are mounted in the area of the cone 62, so they can each pivot about a fulcrum 66. The fulcrums 66 are arranged so they are stationary in relation to the exterior housing 44, as with the fulcrums 57. One arm of the lever 65 is acted upon by a compression spring 67 in the direction of the cone 62, while the other arm is designed as a claw 68 and can engage behind the undercut 40.

Similar to the operation of a ballpoint pen, the second toothed ring 52 provides a pushbutton functionality. The appliance 10 is placed on the cone head 39 with the battery unit 37. The cone head presses against the interior housing 45 via the first toothed ring 51 and moves the interior housing 45 in relation to the exterior housing 44 against the pressure of the spring 46. In doing so, the first toothed ring 51 rotates by a defined angle with the same direction of rotation by cooperation of the inclined surfaces and/or teeth between the two rings 51, 52. Due to the arrangement of the rotatable disk 50, the interior housing 45 does not rotate with the rotatable disk 50. At the same time, the levers 56, 65 are pivoted by contact with the respective cone 55, 62 to close the claw 59 and to open the claw 68. In this way, the battery unit 37 is mechanically and electrically connected to the charging station and can remain locked in place while the appliance 10 is uncoupled from the battery unit 37.

The appliance 10 with the cone head 38 may then be coupled to another battery unit (not shown), which is held on the charging station 13.

By analogy to with the ballpoint pen, the interior housing 45 is similar in function to the ballpoint pen cartridge, while the exterior housing 44 is like the ballpoint pen casing.

Flexible electric lines 69 are provided to the contact pair 54 on the cone 55 to allow relative movement of the interior housing 45 and/or the second toothed ring 52 relative to the exterior housing 44.

Thus, in some embodiments, an up-and-down movement of the battery unit is sufficient for coupling the battery unit 37 to the charging station 13 and for uncoupling the battery unit from the appliance 10. Conversely, the same movement applies to receiving the new battery unit from the charging station and coupling it to the appliance 10.

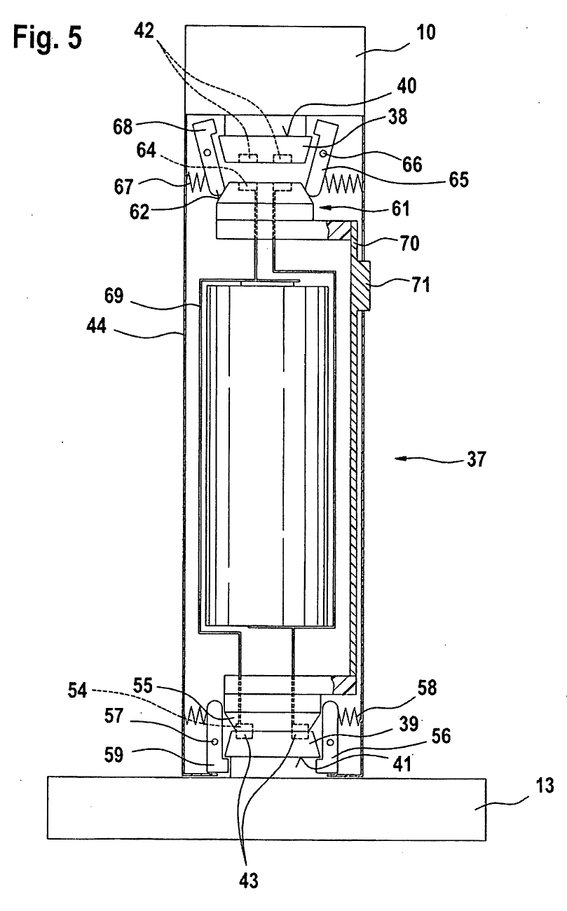

Another similar embodiment is described with reference to FIG. 5. Parts with the same function are labeled with the same numerals. Battery unit 37 is coupled to the charging station 13 by a linear plugging movement. A sliding device 70 is provided. For mechanical locking of the coupling 9b between the battery unit 37 and the charging station 13 on the one hand and for unlocking the coupling 8b between the battery unit and the appliance 10 on the other hand. Sliding device 70 includes a slide button 71 which is accessible on the exterior circumference of the exterior housing 44. By sliding the button 71 in the longitudinal direction of the battery unit, the cones 55, 62 are simultaneously moved in the direction of the charging station 13 or the appliance 10. For coupling to the charging station 13, the button 71 is moved in the direction of the charging station 13. The free arms of the levers 56 therefore run onto the cone, so that the claws 59 engage behind the undercuts 41 and mechanically lock the battery unit to the charging station 13. The contact pairs 43 and 54 are thus pressed against one another, so that high currents can be transmitted.

On the other side of the battery unit, the levers 65 are moved by the cooperation of the cone 62 and the springs 67 to open the claws 68, so that the latter no longer engage behind the undercut 40 and the mechanical coupling 8b to the appliance 10 can be unlocked. At the same time, the head 61 with the contact pairs 64 is lifted up from the contact pairs 42, so that the electric connection is also broken.

The two cones 55, 62 are rigidly coupled together by the slide mechanism with a fixed distance between them. The transfer of the movement of the slide button 71 to the cones 55, 62 and the claws 59, 68 is such that the claws are operated to lock the mechanism in the direction of which the button 71 is moved. This improves the ergonomic properties of the device. After attaching the appliance 10 with the battery unit 37 to the charging station 13, only a movement of the slide button 71 in the direction of the charging station 13 is necessary to release the lock on the one end and to unlock it on the other end. Similarly, a charged battery unit (not shown) is picked up from the charging station 13. The button 71 is then moved in the direction of the appliance 10.

The electric contacts and/or contact pairs are shown in the figures only as an example. Other spatial arrangements and embodiments of the contacts are possible, for example, the contacts for the embodiments of FIGS. 4 and 5 could be used with the embodiment of FIG. 3 and vice versa.

A particular embodiment provides independence of the angle of rotation of the battery unit in relation to the charging station or to the appliance and further provides polarity reversal protection.

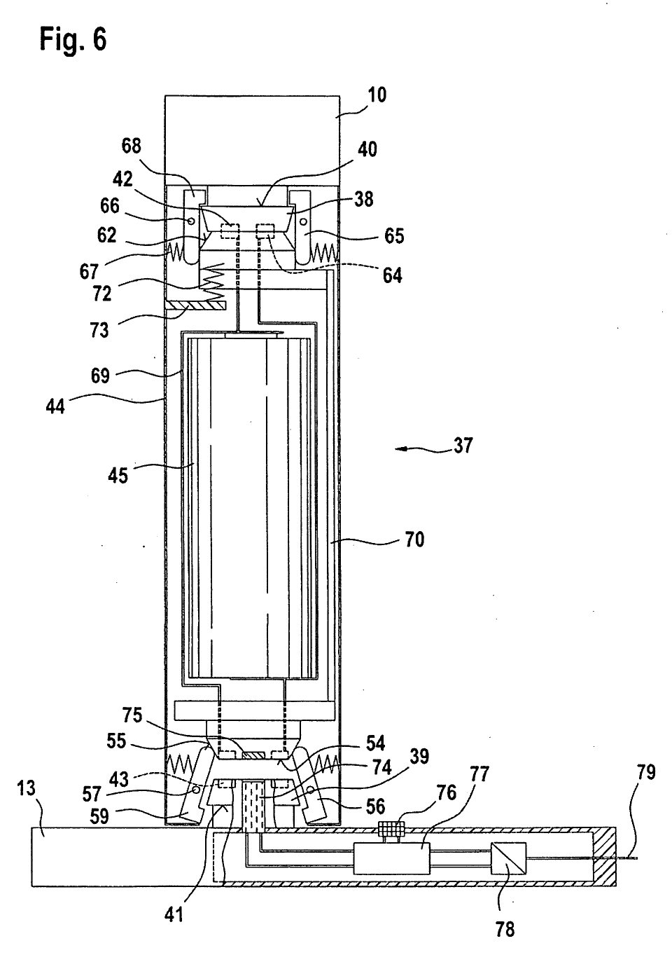

An electromagnetically controlled lock for the battery unit 37 is provided on the charging station 13 and on the appliance 10 in the embodiment according to FIG. 6. Initially, the battery unit is coupled to the appliance 10, as also depicted in FIG. 6. The claws 68 grip behind the undercut 40 on the cone head 38, so that the cone 62 is in contact with the cone head 38 and the contact pairs 42 and 64 are electrically connected to one another. This condition is stable without any external influence due to the force of a compression spring 72 between the cone 62 and a counter bearing 73.

An electromagnet 74 is arranged in the cone head 39 and acts on a metal body 75 in the cone 55 when the current flows, thereby drawing the cone 55 to the cone body 39. In doing so, the levers 56 engage behind the undercut 41 by acting upon the outside surfaces of the cone 55. Furthermore, the contact pairs 54 come to rest on the contact pairs 43. In this position (not shown here), the metal body 75 is in close proximity or contact with the electromagnet 74.

The cone 55 is rigidly connected to the cone 62 via the slide mechanism 70, as in the embodiment according to FIG. 5. Accordingly the cone 62 moves together with the cone 55, so that the claws 68 are released from the undercut 40 to separate the contact pairs 42, 64. In doing so, the force of the electromagnet 74 acts against the force of the spring 72. As a result, the battery unit 37 is uncoupled from the appliance 10 and is coupled to the charging station 13.

Electric operation of the electromagnet 74 is accomplished by a switch and/or a pushbutton 76 on the charging station 13 close to the battery unit 37. An electric controller 77 assigned to the pushbutton 76 is designed so that a current flow is established by operation of the pushbutton. Accordingly, the electromagnet 74 remains active even after the first operation of the pushbutton so that the battery unit 37 is kept coupled to the charging station 13. By means of a second operation of the pushbutton 76, the electromagnet 74 is deactivated and the spring 72 returns the slide mechanism 70 with the cones 62, 55 upward. The battery unit 37 is then uncoupled from the charging station 13 and coupled to the appliance 10.

A power pack 78 is provided for supplying electric power, to the power supply system via a power supply cable 79.

In this embodiment, a simple plugging motion can be performed with one hand for coupling the battery unit 37 to the charging station 13. The pushbutton 76 is advantageously operated with the second hand. With the first hand, the appliance 10 can be lifted up from the battery unit 37 immediately thereafter and placed on a charged battery unit connected to the charging station 13 (according to FIG. 1). This battery unit (not shown) is also held by a cone with an electromagnet and a pushbutton.

In the exemplary embodiments shown here, the mechanical couplings 8c and 9c and/or locking mechanisms on the one hand and the electric contacts on the other hand are separated from one another simultaneous mechanical coupling or locking and electrical connection can also be advantageous, e.g., the coupling force also provides a contact force. A high contact force promotes a low electric transitional resistance. For example, contact surfaces of the claws 59, 68 and the receptacles having cone heads 38, 39 can include electric contacts. The force with which the claws 59, 68 are pressed against the receptacles is proportional to the force with which the electric contacts are compressed. Since the claws 59, 68 are movable, either the electric lines to the contact surfaces on the claws are movable or the current is supplied via the fulcrums 57, 66.

1. A system comprising a charging station, an electric appliance and a first removable, rechargeable battery unit, wherein:
the electric appliance and first battery unit are connectable to form a first coupling for powering the electric appliance;
the charging station defines a receptacle configured to hold and charge the first battery unit;
the charging station and first battery unit are connectable to form a second coupling for charging the first battery unit;
wherein the first coupling and the second coupling are configured such that respective formation of one coupling and separation of the other coupling are both readily accomplished by one-handed operation.

2. The system according to claim 1, wherein the first and second coupling each include a mechanical lock and electric contacts.

3. The system of claim 1, further comprising a second receptacle defined in the charging station and configured to hold and charge one of the first battery unit and a second battery unit.

4. The system according to claim 1 wherein the battery unit includes electric contacts positioned on opposed surfaces of the battery unit.

5. The system according to claim 1, wherein the first and second couplings are configured to prevent polarity reversal of the battery unit with electric contacts in the respective coupling.

6. The system according to claim 1, wherein the battery unit is configured to prevent polarity reversal of electric contacts on the battery unit relative to electric contacts on the appliance or charging station.

7. The system according to claim 1, wherein the battery unit is configured to be positionally reversible between the first and second couplings.

8. The system of claim 7, wherein the first and second couplings are substantial symmetrical to accommodate positional reversal of the battery unit.

9. The system according to claim 1, wherein at least one of the first and second couplings is configured to be made or uncoupled by rotation of the appliance.

10. The system according to claim 9, wherein the battery unit is configured to be locked to the charging station by rotation of the appliance about a longitudinal axis of the appliance and the battery unit.

11. The system according to claim 1, wherein one of the first and second couplings is configured to be made or uncoupled by operation of a spring-pushbutton system similar to that of a ballpoint pen.

12. The system according to claim 11, wherein the battery unit includes an exterior housing and an interior housing movable within the exterior housing against the force of a spring.

13. The system according to claim 1, wherein the battery unit includes an actuator operable from the battery exterior to engage mechanical locks between the battery unit and one of the charging station and the appliance to form one of the first and second couplings.

14. The system according to claim 13, wherein the actuator is a slider.

15. The system according to claim 1, wherein one of the appliance and the charging station includes a rigid locking member for coupling the battery unit.

16. The system according to claim 15, wherein the rigid locking member comprises a coupling pin defining an undercut, and the battery unit comprises a movable locking member configured to engage the undercut.

17. The system according to claim 15, wherein the battery unit comprises movable locking levers movable by contact with movable leading surfaces of a conical pin on one of the appliance and the charging station.

18. A device comprising:
an electric appliance which is operated with a replaceable, rechargeable battery unit;
a charging station including two or more receptacles for holding and charging two or more battery units;
first connecting means between the battery unit and the appliance; and
second connecting means between the battery unit and the charging station, such that the battery unit when connected to the appliance can be uncoupled from the appliance and coupled to the charging station for charging by one-handed operation and the battery unit when connected to the charging station can be coupled to the appliance and uncoupled from the charging station by one-handed operation.

19. A method of alternately coupling a rechargeable battery to an appliance and a charging station comprising the steps of:
coupling the battery to the charging station;
gripping the appliance with one hand;
coupling the appliance to the battery on the charging station while gripping the appliance with one hand and without gripping the battery or the charging station; and
uncoupling the battery from the charging station while gripping the appliance with one hand without gripping the battery or the charging station.

20. The method of claim 19, wherein the coupling of the appliance to the battery and the uncoupling of the battery from the charging system are performed substantially simultaneously by rotating the appliance in contact with the battery.
